(19) United States
(12) Patent Application Publication
(10) Pub. No.: US 2020/0130759 A1
(43) Pub. Date: Apr. 30, 2020

(54) Tugger Train Trailer for a Tugger Train

(71) Applicant: LR Intralogistik GmbH, Woerth an der Isar (DE)

(72) Inventor: Fritz Berghammer, Landshut (DE)

(21) Appl. No.: 16/603,630

(22) PCT Filed: May 4, 2018
(86) PCT No.: PCT/EP2018/061458

§ 371 Date: Oct. 8, 2019

(30) Foreign Application Priority Data
May 18, 2017 (DE) 10 2017 110 862.9

(51) Int. Cl. B62D 59/04; B60L 50/60

(52) U.S. Cl. CPC B62D 59/04; B60L 2200/28; B60L 50/66

(57) ABSTRACT

The invention relates to a route train trailer (2a; 2b; 2c) for a route train (1), wherein the route train trailer (2a; 2b; 2c) has a chassis (3; 3a, 3b) with at least one wheel (4). The wheel (4) is drivingly connected to an electric travel drive motor (7). The electric travel drive motor (7) is controlled by an electronic controller which actuates the travel drive motor (7) depending on an acceleration pulse (B) and/or delay pulse (V) acting on the route train trailer (2a; 2b; 2c).

This invention relates to a tugger train trailer for a tugger train, whereby the tugger train trailer has a chassis with at least one wheel.

Tugger trains that consist of a tugger vehicle such as a tractor, for example, and a plurality of tugger train trailers on which the loads are transported are being used with increasing frequency for the transport of loads within a plant, such as in the production area of production plants, for example.

The tugger train trailers are in this case connected among one another and with the tractor vehicle with corresponding drawbars.

On tugger train trailers of the prior art, the wheels of the chassis are in the form of non-driven and therefore idler wheels. The traction power to move the tugger train trailer and the braking power to brake the tugger train trailer are therefore applied by the tractor vehicle. If a tugger train has a plurality of tugger train trailers, the tractor vehicle must have a correspondingly high traction power or braking power. The traction power or braking power and therefore the size of the tractor vehicle increases proportionally with the cargo load of the tugger train or the number of tugger train trailers. The heavier the cargo load of the tugger train, the greater the traction power or braking power of the tractor vehicle must be.

In addition, on tugger train trailers of the prior art, on which the wheels of the chassis are in the form of non-driven and therefore idler wheels, the traction power to move the tugger train trailer and the braking power to brake the tugger train trailer is transferred via the drawbars as well as via the tugger train trailers. On a tugger train with a plurality of tugger train trailers, the train length, i.e. the number of tugger train trailers coupled to one another, is therefore limited by the stability of the yokes and the stability of the tugger train trailers as well as by the train length, because the longer the tugger train, i.e. the more tugger train trailers are coupled together, the greater the forces acting on the yokes and the tugger train trailers.

The object of this invention is to make available a tugger train trailer of the type described above on which the disadvantages cited above are avoided.

This object is accomplished according to the invention in that the wheel is in a driven connection with an electric travel drive motor and the electric travel drive motor is controlled by an electronic control device that actuates the travel drive motor as a function of an acceleration pulse and/or a deceleration pulse that acts on the tugger train trailer. The wheels of the tugger train trailer are therefore wheels that are driven by means of an electric travel drive motor. The electronic control device thereby controls the travel drive motor as a function of an acceleration pulse and/or deceleration pulse that acts on the tugger train trailer, whereby the acceleration pulse and/or the deceleration pulse is generated by the tractor vehicle to which the tugger train trailer is connected. If an acceleration pulse that acts on the tugger train trailer is detected by the electronic control device, the electronic control device actuates the travel drive motor so that the wheel moves independently and accelerates and travels synchronously with the tractor vehicle. The wheel of the tugger train trailer therefore has the same acceleration and/or speed as the tractor vehicle. If the electronic control device detects a deceleration pulse acting on the tugger train trailer, the electronic control device actuates the travel drive motor so that the wheel decelerates independently and decelerates or brakes synchronously with the tractor vehicle. It is advantageous that the traction force for the travel of the tugger train trailer and the braking force for the braking of the tugger train trailer are applied by the travel drive motor of the tugger train trailer itself. If a tugger train has a plurality of tugger train trailers, the traction force or braking force and therefore the size of the tractor vehicle is no longer dependent on the cargo load of the tugger train or the number of tugger train trailers. With the tugger train trailers according to the invention, a tugger train with a large number of tugger train trailers or with a heavy cargo load can therefore be operated with a small tractor vehicle, because all the the tractor vehicle has to do is specify the direction of travel and move itself, as well as generate the corresponding acceleration and/or deceleration pulse that acts on the tugger train trailers, but no longer has to generate the traction forces and braking forces for the tugger train trailers. With the tugger train trailers according to the invention, it therefore also becomes possible for conventional commercial driverless transport systems or driverless transport vehicles, also called FTS, to be used as the tractor vehicle of a tugger train that has one or more tugger train trailers according to the invention.

In addition, on the tugger train trailer on which the wheels of the chassis are in the form of driven wheels, the traction force to move the tugger train trailer and the braking force to brake the tugger train trailer are no longer transmitted via the drawbar or via the tugger train trailers. With the wheels of the tugger train trailer driven by the travel drive motor, the drawbar is relieved of the load of the traction forces and braking forces. Therefore on a tugger train trailer with a plurality of tugger train trailers according to the invention the train length, i.e. the number of tugger train trailers that are connected to one another, is no longer limited by the stability of the drawbars and the stability of the tugger train trailers.

In one advantageous embodiment of the invention, the electronic control device is in an operative connection with a sensor device that detects the acceleration pulse and/or the deceleration pulse acting on the tugger train trailers.

In one advantageous embodiment of the invention, the sensor device is an acceleration sensor that detects the acceleration in the horizontal direction acting on the tugger train trailer as an acceleration pulse or a deceleration pulse.

It is particularly advantageous if, as in one development of the invention, the wheel is provided with the electric travel drive motor, the electronic control device and the sensor device. The driven wheel can therefore easily be located on the tugger train trailer in place of a pure idler wheel.

The electric travel drive motor is advantageously in the form of a wheel-hub motor. The wheel therefore has an integrated travel drive motor and thus an integrated drive mechanism. The wheel equipped with the wheel hub motor therefore occupies less space and can be installed in a simple manner on existing tugger train trailers.

The wheel is advantageously provided with a battery to supply power to the electric travel drive motor. The wheel is therefore provided with the electric travel drive motor, the electronic control device, the sensor device and the battery to supply power to the electric travel drive motor, so that the wheel has all the components for travel operation and braking operation.

The tugger train trailer can alternatively or additionally be provided with a battery to supply power to the electric travel drive motor of the wheel.

The invention further relates to a transport system comprising a tractor vehicle and at least one tugger train trailer according to the invention coupled to the tractor vehicle. A transport system of this type has the advantage that the traction power to move the tugger train trailer and the braking power to brake the tugger train trailers is applied by the corresponding travel drive motors of the wheels of the tugger train trailers themselves. If a tugger train has a plurality of tugger train trailers, the traction force or braking force and thus the size of the tractor vehicle is no longer dependent on the weight of the cargo load of the tugger train or the number of tugger train trailers. With the transport system according to the invention, a tugger train with a large number of tugger train trailers or with a heavy cargo load can be operated with a small tractor vehicle because all the tractor vehicle has to do is to specify the direction of travel and move itself, as well as generate the corresponding acceleration pulse and/or deceleration pulse that acts on the tugger train trailers, but no longer has to produce the traction forces and braking forces for the tugger train trailers. In addition, with the transport system according to the invention, the traction forces to move the tugger train trailers and the braking forces to brake the tugger train trailers are no longer transmitted via the drawbar and/or via the tugger train trailers, so that the drawbar is relieved of the traction forces and braking forces.

The tractor vehicle is advantageously provided with a battery to supply power to the electric travel drive motor of the wheel.

The battery of the tractor vehicle can in this case be in the form of a traction battery of the tractor vehicle, which supplies electrical energy to an electric drive system of the tractor vehicle.

Additional advantages and details of the invention are described in greater detail below with reference to the exemplary embodiments illustrated in the accompanying schematic figures. In the drawings:

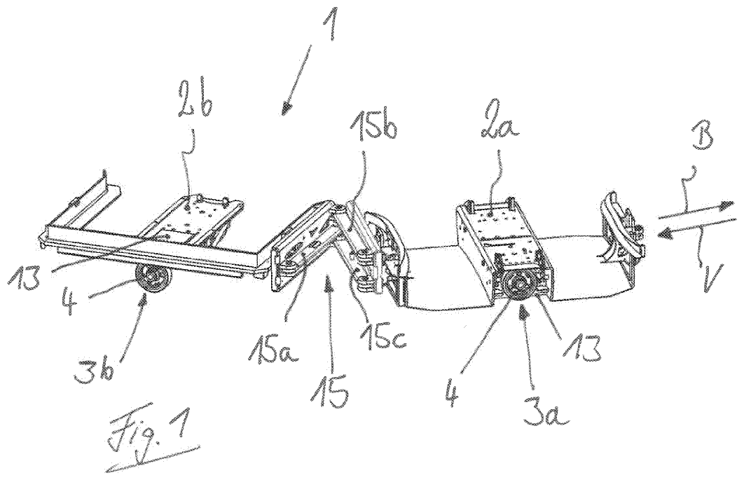

FIG. 1 shows a tugger train with two tugger train trailers according to the invention which are coupled to each other by means of a drawbar,

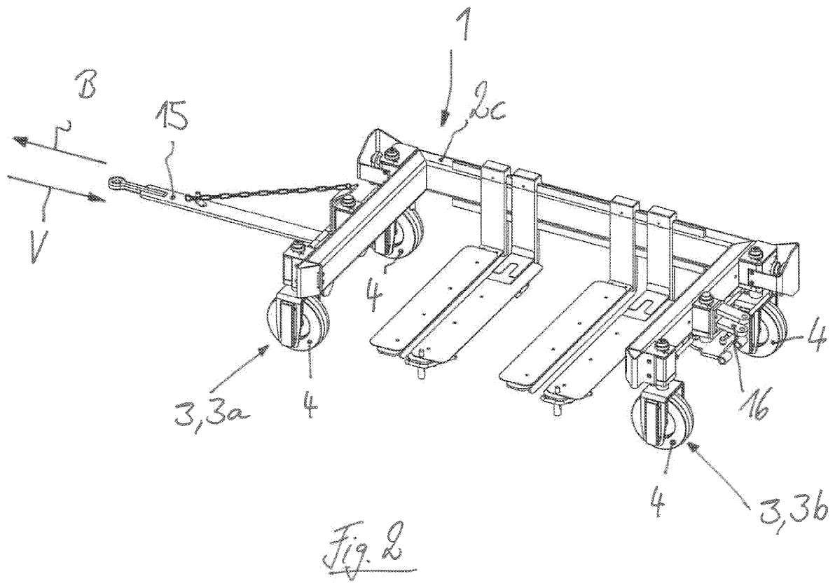

FIG. 2 shows an additional exemplary embodiment of a tugger train trailer according to the invention of a tugger train, and

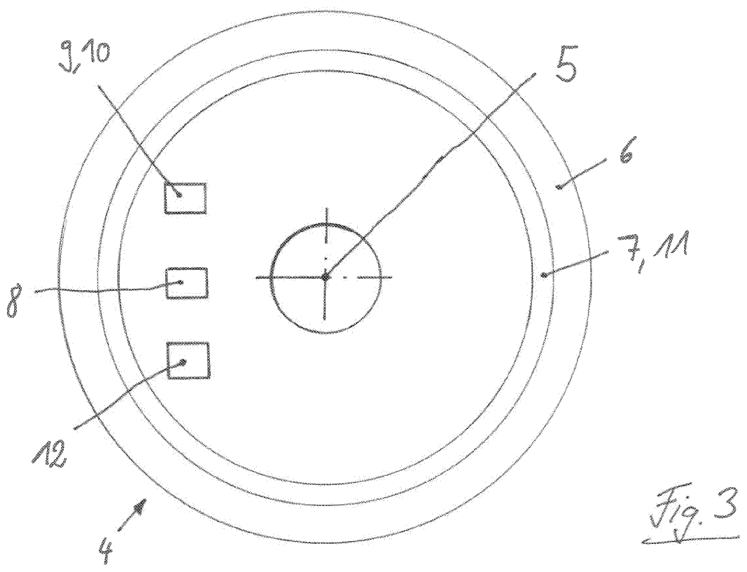

FIG. 3 shows a wheel according to the invention of the tugger train trailer illustrated in FIG. 1 or FIG. 2.

FIG. 1 shows a perspective view of a tugger train 1 with two tugger train trailers 2a, 2b according to the invention.

The two tugger train trailers 2a, 2b each have a chassis 3a, 3b with which the corresponding tugger train trailer 2a, 2b runs on a roadway surface. The chassis 3a, 3b each have at least one wheel 4.

The two tugger train trailers 2a, 2b are connected to each other by means of a drawbar 15.

In the exemplary embodiment illustrated in FIG. 1, the drawbar 15 is formed by at least two or three intersecting drawbar links 15a, 15b, 15c. However, the invention is not restricted to this embodiment of a drawbar 15.

In the exemplary embodiment of the tugger train trailer 2a, 2b illustrated in FIG. 1, the wheels 4 are non-steered wheels. The chassis 3a, 3b are each oriented essentially centrally in the longitudinal direction of the tugger train trailers 2a, 2b.

FIG. 2 shows an additional exemplary embodiment of a tugger train trailer 2c of a tugger train 1 according to the invention.

The tugger train trailer 2c illustrated in FIG. 2 has a chassis 3 which consists of a forward chassis 3a and a rear chassis 3c, with which the tugger train trailer 2c runs on a roadway surface. The forward chassis 3a and the rear chassis 3c each have two wheels 4. The wheels 4 of the forward chassis 3a and/or the wheels 4 of the rear chassis 3c can each be in the form of steerable wheels.

The tugger train trailer 2c shown in FIG. 2, for the connection with a preceding tractor or a preceding tugger train trailer, has a drawbar 15 on the front. The tugger train trailer 2c in FIG. 2 has a trailer coupling 16 on the rear for the connection with a trailing tugger train trailer.

FIG. 3 is a schematic drawing showing a wheel 4 of the tugger train trailer 2a, 2b in FIG. 1 or of the tugger train trailer 2c in FIG. 2.

The wheel 4 has a wheel hub 6 that is rotational around an axis of rotation 5 and is in a driven connection with an electric travel drive motor 7 and is driven by it. The electric travel drive motor 7 is controlled by an electronic control device 8 which actuates the travel drive motor 7 as a function of an acceleration pulse B and/or deceleration pulse V that acts on the tugger train trailer 2a or 2b or 2c, which is exerted on the tugger train trailers 2a or 2b or 2c by a tractor vehicle not shown in any further detail in FIG. 1.

For this purpose the electronic control device 8 is in operative communication with a sensor device 9 which detects the acceleration pulse B and/or deceleration pulse V acting on the tugger train trailer 2a or 2b or 2c.

The sensor device 9 can, for example, be in the form of an acceleration sensor 10, which detects the acceleration on the tugger train trailer 2a or 2b or 2c in the horizontal travel direction.

The wheel 4 is preferably provided with the electric travel drive motor 7, the electronic control device 8 and the sensor device 9.

For this purpose, the electric travel drive motor 7 is preferably in the form of a wheel hub motor 11 that is built into the wheel 4.

The wheel 4 can also be provided with a battery 12 to supply power to the electric travel drive motor 7.

The tugger train trailer 2a, 2b or 2c can alternatively or additionally be provided with a battery 13 to supply power to the electric travel drive motor 7 of the wheel 4.

Not illustrated in further detail in FIGS. 1 and 2 is a tractor vehicle to which the tugger train trailers 2a, 2b and 2c are hitched. Alternatively or additionally, the tractor vehicle can be provided with a battery to supply power to the electric travel drive motor 7 of the wheel 4.

The electronic control device 8 is configured to that when an acceleration pulse B and/or a deceleration pulse V acts on the tugger train trailers 2a or 2b or 2c, the acceleration pulse B and/or the deceleration pulse V is set to zero so that the wheel 4 idles corresponding to the acceleration and/or speed of the tractor vehicle, so that the tugger train trailer 2a or 2b or 2c travels at the same speed as the tractor vehicle.

The tugger train trailer 2a or 2b or 2c equipped with the wheel 4 according to the invention makes possible a series of advantages:

In a tugger train, equipping the wheels 4 of the tugger train trailer 2a, 2b, 2c with the travel drive motor 7 makes it possible to sharply reduce the traction force of the tractor vehicle. With the tugger train trailers 2a, 2b, 2c according to the invention, a tugger train with a large number of tugger train trailers 2a, 2b 2c or with a heavy cargo load can be operated with a small tractor vehicle, because all the tractor vehicle has to do is specify the direction of travel, move itself and generate the acceleration pulse B and/or deceleration pulse V corresponding to the tugger train trailers 2a, 2b, 2c, but no longer needs to apply the traction forces and/or braking forces for the tugger train trailers 2a, 2b, 2c because these forces are produced by the wheels 4 themselves which are equipped with the travel drive motors 7.

In addition, on the tugger train trailers 2a, 2b, 2c according to the invention, the traction forces to move the tugger train trailers 2a, 2b, 2c are no longer transmitted via the drawbars 15 or via the tugger train trailers 2a, 2b, 2c. With the wheels 4 of the tugger train trailers 2a, 2b, 2c driven by the corresponding traction drive motor 7, the drawbars 15 are relieved of the traction forces.

The tugger train trailers 2a, 2b, 2c according to the invention make it possible to assemble longer tugger trains with a large number of tugger train trailers 2a, 2b, 2c.

With the tugger train trailers 2a, 2b, 2c according to the invention there is also an improved braking action of a tugger train 1 with a precisely controlled deceleration of the tugger train 1 and an improved starting action and braking action on ramps or slopes, because each tugger train trailer 2a, 2b, 2c accelerates and decelerates for itself with the wheels 4 equipped with the travel drive motors 7.

1. A tugger train trailer for a tugger train, comprising: a chassis with at least one wheel, wherein the wheel is in a driven connection with an electric travel drive motor and the electric travel motor is controlled by an electronic control device which actuates the travel drive motor as a function of an acceleration pulse, a deceleration pulse, or an acceleration pulse and a deceleration pulse acting on the tugger train trailer.

2. The tugger train trailer according to claim 1, wherein the electronic control device is in an operative connection with a sensor device which detects the acceleration pulse, the deceleration pulse, or the acceleration pulse and the deceleration pulse acting on the tugger train trailer.

3. The tugger train trailer according to claim 1, wherein the sensor device is an acceleration sensor.

4. The tugger train trailer according to claim 2, wherein the wheel is provided with the electric travel drive motor, the electronic control device and the sensor device.

5. The tugger train trailer according to claim 1, wherein the electric travel drive motor is a wheel hub motor.

6. The tugger train trailer according to claim 1, wherein the wheel is provided with a battery to supply power to the electric travel drive motor.

7. The tugger train trailer according to claim 1, further comprising a battery to supply power to the electric travel drive motor of the wheel.

8. A transport system comprising a towing vehicle and at least one tugger train trailer coupled to the towing vehicle according to claim 1.

9. The transport system according to claim 8, wherein the towing vehicle is provided with a battery to supply the electric travel drive motor of the wheel.

10. The transport system according to claim 9, wherein the battery is a traction battery of the towing vehicle.
